(19) United States
(12) Patent Application Publication
(10) Pub. No.: US 2019/0091794 A1
(43) Pub. Date: Mar. 28, 2019

(54) WELDING TONGS

(71) Applicant: WITTENSTEIN SE, Igersheim (DE)

(72) Inventors: Tobias Burger, Igersheim (DE); Thomas Wilhelm, Creglingen-Reinsbronn (DE)

(21) Appl. No.: 16/139,494

(22) Filed: Sep. 24, 2018

(30) Foreign Application Priority Data
Sep. 22, 2017 (DE) 102017122049.6

(51) Int. Cl. B23K 11/11; B23K 11/31; F16H 1/28

(52) U.S. Cl. CPC B23K 11/115; F16H 1/28; B23K 11/314

(57) ABSTRACT

Welding tongs (1), especially X-welding tongs (1) for resistance spot welding, with a first tong arm (11), a second tong arm (12), and a drive unit (2) comprising a motor (4) and a gearing (6) for rotating the first tong arm (11) relative to the second tong arm (12) about an axis of rotation (14) of the welding tongs (1), wherein the motor (4) and the gearing (6) are arranged coaxially and the second tong arm (12) is fastened to the housing in an abutment plane (29), which is situated on the motor side of an outer driven bearing plane of the drive unit (2).

### FIELD OF THE INVENTION

The invention relates to welding tongs and a use thereof according to the disclosure.

### PRIOR ART

Welding tongs for resistance spot welding are typically designed as so-called X-welding tongs or X-type welding tongs. Such welding tongs have two tong arms, on which electrodes are arranged for the resistance spot welding. The name X-welding tongs therefore comes from the fact that the X-welding tongs still used customarily today have tong arms which are prolonged beyond the pivot point in order to situate a kinematics for the driving of the X-welding tongs on the side facing away from the electrodes.

For the opening and closing movement of the welding tongs there must be provided a drive unit, which entails restrictions in terms of weight as well as the space requirement for the design of the X-welding tongs. In order to avoid such drawbacks, the prior art discloses X-welding tongs which have a drive unit attached directly at the pivot point of the welding tongs.

The laid-open patent application DE 10 2011 054 376 A1 discloses motor-driven X-welding tongs for resistance welding, having a motor which can rotate a first tong arm of the welding tongs relative to a second tong arm across a step-down gearing. However, even these reduced-size welding tongs as compared to other welding tongs known in the prior art have dimensions which are too large for certain installation and application situations.

### DISCLOSURE OF THE INVENTION

The problem which the invention proposes to solve is to improve X-welding tongs for resistance spot welding that are known in the prior art. In particular, it should provide welding tongs which have a simple and compact layout.

The problem is solved with welding tongs, especially X-welding tongs for resistance spot welding as disclosed herein and a use also disclosed herein.

A first aspect of the invention relates to welding tongs, especially X-welding tongs for resistance spot welding, with a first tong arm, a second tong arm, and a drive unit comprising a motor and a gearing for rotating the first tong arm relative to the second tong arm secured on a housing of the drive unit about an axis of rotation of the welding tongs, wherein the motor and the gearing are arranged coaxially in the axis of rotation, wherein the second tong arm is fastened to the housing in an abutment plane, which is situated on the motor side of an outer driven bearing plane of the drive unit.

In typical embodiments of the welding tongs, the drive unit has a coaxial design. This means, in particular, that the motor and the gearing of the drive unit are arranged coaxially relative to the second tong arm for the turning of the first tong arm. Coaxially means in particular that the driven shaft of the motor is arranged coaxially to a driven element of the gearing. Preferably, the motor and the gearing are arranged coaxially in an axis of rotation about which the first tong arm turns relative to the second tong arm when the drive unit is activated. The arranging of motor and gearing coaxially in the axis of rotation offers the advantage of an especially compact design. In order to further improve or optimize such an especially compact design, a driven shaft of the motor or a driven element connected to the driven shaft of the motor may engage with the gearing.

This is possible in particular with coaxial gearing or with gearings having cam disks, which have an interior situated drive unit, such as a driven cam disk. One example of such a coaxial gearing is a planetary gearing, in which the sun wheel is driven by the motor. Further examples of gearings which are used in connection with the invention are coaxial gearings with a cam disk as a drive element. Another preferred example is a stress wave gearing, one example of such a gearing being known under the brand name of Harmonic Drive. In embodiments, cycloid gearings can be used as a gearing with internal cam disk. Cycloid gearings have outside situated, fixed bolts in a circular arrangement, similar to the internal gears of the other cam disk gearings.

Gearings with high transmission ratio are used in embodiments in order to provide large torques. Special advantages are afforded by a coaxial gearing with a cam disk for the driving of radially movable teeth, which are held in a tooth carrier. One exemplary layout of such a gearing can be found for example in the application DE 10 2015 105 525 A1. Such gearings are also called here a galaxy gearing and they afford the advantage of a large torque density with extremely compact construction and extreme transmission ratios. These attributes make them especially advantageous for use in welding tongs.

In general, preferred gearings for typical embodiments of welding tongs have a coaxial gearing with an internal ring gear. The internal ring gear is preferably joined firmly to a housing of the gearing or the drive unit. In coaxial gearings with radially movable teeth, a tooth carrier in which the teeth are arranged radially movably is preferably connected to a driven element of the gearing or the drive unit of the welding tongs. This produces an especially compact layout.

Typical embodiments of the invention comprise several gearing stages, such as a first gearing stage and a second gearing stage. The examples mentioned herein for single-stage gearings such as for example a coaxial gearing in various embodiments are typically used as the first gearing stage or second gearing stage. A typical example of a gearing of a drive unit of one embodiment of the invention comprises a planetary gearing as the first gearing stage, i.e., a planetary prestage, and a coaxial gearing with cam disk and radially movable mounted teeth or a galaxy gearing as the second gearing stage. Typically, the first stage has a transmission ratio of at least 2:1 or 3:1 or a transmission ratio of at most 9:1 or at most 10:1 and the second stage has a transmission ratio of more than 10:1 or at least 16:1. Other embodiments comprise two planetary gearings or two galaxy gearings as two gearing stages.

Preferably, the motor and the gearing are arranged in a common housing. The term “common housing” means here, in particular, that gearing and motor do not have any units with projecting shafts, for example, and in particular no driven shaft of the motor projecting from a housing or no drive shaft of the gearing projecting from a housing of the gearing. In embodiments, the shaft between motor and gearing is a single piece, or clutch-free, in order to make possible a compact layout. Preferably, the housing is at least two pieces, e.g., with a motor housing portion and a gearing housing portion, the two-piece parting of the housing of the drive unit running along a plane which lies between motor and gearing. Typically the gearing is accommodated in the gearing housing portion and the motor in the motor housing portion. This makes it possible to screw different motor sizes onto a gearing, in order to produce modular welding tongs of different size and strength or speed. In embodiments, the gearing housing portion of the gearing directly adjoins the motor housing portion, in order to achieve a compact and modular design. The second tong arm may be fixed to the motor housing portion or to the gearing housing portion. In further typical embodiments, a flange is arranged between the motor housing portion and the gearing housing portion, on which the second tong arm is directly or indirectly secured. This enables a compact, stable and modular design.

In typical embodiments, a driven element of the gearing is double mounted. In embodiments with a galaxy gearing as the second gearing stage or the single gearing stage, typically a tooth carrier of the galaxy gearing in which teeth are held in radially movable fashion is designed as the driven element and is twice mounted. This means, in particular, that the driven element has two bearing planes, which are perpendicular to the direction of the axis of rotation and are offset in the direction of the axis of rotation. Preferably, an internal ring gear of a coaxial gearing as the gearing of the drive unit is arranged between an outer driven bearing and an inner driven bearing. Or otherwise put, the inner driven bearing and the outer driven bearing are arranged axially on either side of the internal ring gear of the planetary gearing or the galaxy gearing. This means, in particular, that the internal ring gear is arranged between two bearing planes of a driven element of the gearing. The driven element for example may comprise a tooth carrier of a gearing with cam disk for the driving of radially movable teeth or a double mounted planet carrier. One example of such a planetary gearing is found in EP 0 824 640 B1. In a gearing with cam disk for driving of radially movable teeth (galaxy gearing), the driven element comprises the tooth carrier in which the teeth are held in a radially movable manner, wherein the tooth carrier of the driven element is preferably mounted on either side of the plane of the cam disk and the radially movable teeth. The bearing facing away from the motor is called here the outer driven bearing.

Preferably the first tong arm is mounted by a bearing of the gearing and able to turn about the axis of rotation. Especially preferably, the first tong arm is mounted to turn about the axis of rotation solely by bearings of the gearing. In this way, additional bearings become unnecessary. In the case of especially large or heavily strained welding tongs, another bearing can also be provided in addition, especially a bearing on the side of the first tong arm facing away from the drive unit. In preferred embodiments, the first tong arm is connected to the driven element of the gearing, so that the first tong arm is mounted across the driven bearing of the gearing. In particular for gearings with driven elements having an internal ring gear arranged between the driven bearings, such as a planetary gearing or a coaxial gearing as described in this application, a sufficiently large lever arm is achieved in this way for the mounting of the first tong arm.

In typical embodiments of the welding tongs, the first tong arm is mounted solely across driven bearings of the gearing. This results in an especially compact design and enables a precise alignment of the tong arms, especially orthogonally to the axis of rotation of the drive unit.

The compact design of typical embodiments of welding tongs makes it possible for typical welding tongs to have a compensating bearing, a compensating drive unit or a compensating mechanism to reduce loads, such as an attachment bracket or a robot. These may likewise be secured to the flange in embodiments or an additional flange may be provided for the fastening of such devices on the housing of the drive unit.

Advantageously, the first tong arm has a step in the direction of the drive unit. In typical embodiments, the tong arms are oriented orthogonally to the axis of rotation. At least the first tong arm, preferably only the first tong arm, has a step in preferred embodiments, which has the effect that the plane in which an electrode of the first tong arm is moving is offset with respect to the plane or the region in which the first tong arm is connected to a driven element of the gearing. In this way, the work plane, which is the plane in which the electrode of the first tong arm is moving and in which the working point lies, can be offset with respect to the power takeoff of the drive unit in the direction of the motor. In this way, the work plane is displaced along the axis of rotation in the direction of the drive unit or the motor as compared to the plane in which the first tong arm is fastened to the driven element.

Preferably, the tong arms are designed or at least the step of the first tong arm is designed so that a working point or a welding plane of the welding tongs lies on the motor side of a bearing plane of an outer driven bearing of the gearing. This bearing plane is a plane running perpendicular to the axis of rotation, through an outer driven bearing of the gearing. The bearing plane denotes here the plane in which the radial bearing forces are acting, or in which the center of gravity of the radial bearing forces lies, for example in the case of roller bearings. The working point is preferably the point at which a resistance spot welding occurs.

In typical embodiments, the working point of the welding tongs or the work plane of the welding tongs lies on the motor side of a plane perpendicular to the axis of rotation and extending through an inner driven bearing of the gearing. In other embodiments, the work plane lies at the motor side of a plane which is formed by an internal ring gear of a coaxial gearing of the first gearing stage or by an internal ring gear of a coaxial gearing of the second gearing stage. Such embodiments afford the benefit of an especially favorable weight distribution.

Another independent aspect of the invention relates to a use of the welding tongs in one of the described typical or preferred embodiments for the welding of sheet metal, especially also sheets of aluminum or steel or a metal alloy in general. In particular, in the welding of sheet metal, for example in the fabrication of motor vehicles or the manufacture of general machine parts, the welding tongs afford benefits, since they are compact, stable and powerful, and furthermore high working speeds can be accomplished with the chosen motor-gearing combination.

In typical sample embodiments, the second tong arm is fastened to the housing in an abutment plane, which is situated on the motor side of an outer driven bearing plane of the drive unit. The second tong arm may be arranged on any desired side, such as left or right of the drive unit.

Typically the step of the first tong arm forms an offset, so that a working point and thus also the work plane of the welding tongs lie on the motor side of a fastening plane of the first tong arm.

Typically the working point substantially lies in the abutment plane. Here, “substantially” can mean, for example, that the distance from the working point to the abutment plane is less than 40% or less than 20% or less than 10% of the length of the drive unit or less than 50% or less than 30% or less than 20% of the offset of the step of the first tong arm. For example, “substantially” may also mean that the distance between the work plane in which the working point lies and the abutment plane is less than the thickness of the second tong arm. The abutment plane typically means the plane which is defined by the bearing surface of the second tong arm on a flange or on another fastening surface of the drive unit.

Typically, the first tong arm is mounted by at least one driven bearing of the gearing situated in a driven bearing plane and able to turn about the axis of rotation. Typically, two driven bearings are provided in an inner driven bearing plane, closer to the motor, and in an outer driven bearing plane, further away from the motor. Typically, the inner driven bearing plane substantially coincides with the work plane. In further embodiments, the inner driven bearing plane is distant from the work plane. In typical embodiments, the first gearing stage is provided at least partly on the motor side of the inner driven bearing plane. In other embodiments, the first gearing stage is provided on the side of the inner driven bearing plane distant from the motor.

Typically the second tong arm is configured without a step. This simplifies the design. In other embodiments, the second tong arm has a step. In embodiments with a step of the second tong arm, the offset of the step of the second tong arm is at most 50% or at most 30% as large as the offset of the step of the first tong arm. In this way, the second tong arm becomes more compact and lighter as compared to other embodiments in the prior art.

In typical embodiments, the size ratio of the diameter of the gearing housing portion to the motor housing portion is at least 0.6:1 or at least 0.7:1 or at least 0.8:1 or at most 1:1 or at most 1.2:1 or at most 1.4:1.

The invention may afford for example the following benefits: more compact design, especially in the lengthwise direction of the axis of rotation, symmetrical design, greater power density, greater rigidity, fewer components, better flow of forces, less installation expense, less expense for measuring out and aligning the tong arms or a reduced interference contour.

### BRIEF DESCRIPTION OF THE DRAWINGS

FIG. 1 shows a schematic top view of a sample embodiment of welding tongs;

FIG. 2 shows the welding tongs of FIG. 1 in a schematic side view;

FIG. 3 shows a schematic cross sectional drawing through the welding tongs of FIGS. 1 and 2.

### DESCRIPTION OF SAMPLE EMBODIMENTS

In the following, typical sample embodiments shall be described, where the same reference numbers are used sometimes for the same or similar parts, sometimes also for several different embodiments. Basically, the application is not confined to the different embodiments, but instead the scope is defined by the claims. Sometimes individual parts are explained only in connection with one figure, and insofar as these parts are represented in other figures they are not necessarily described once again.

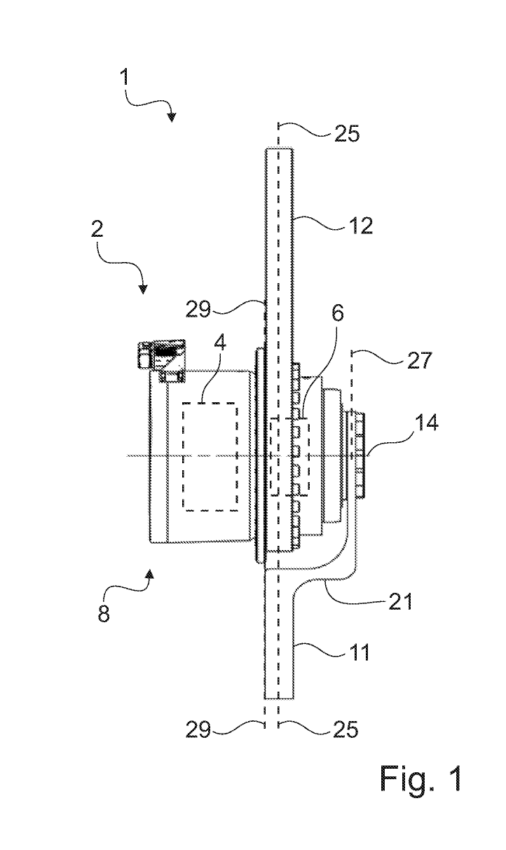

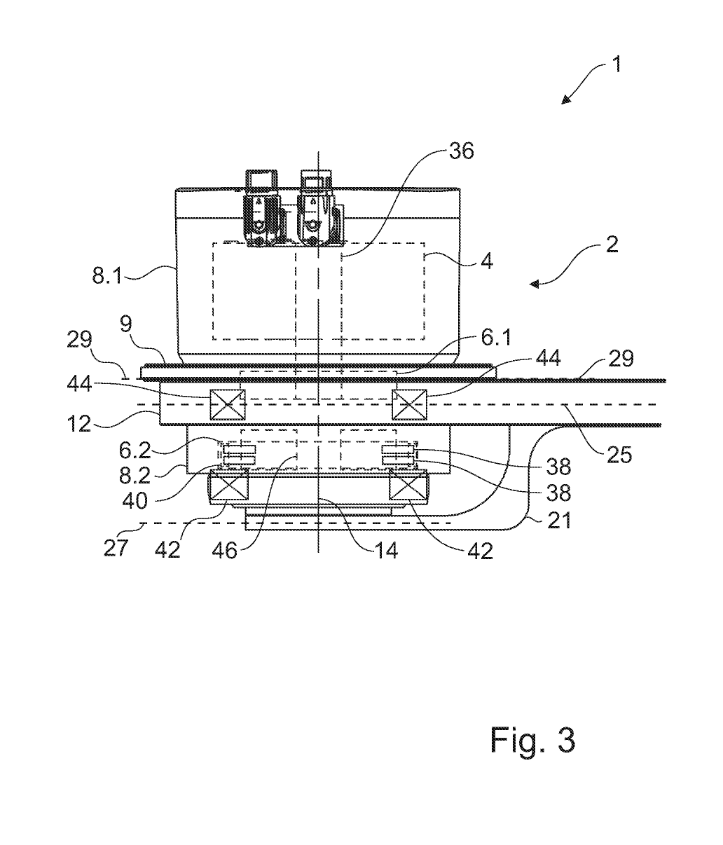

FIG. 1 shows a sample embodiment of welding tongs 1 in a schematic top view. The welding tongs 1 of FIG. 1 are so-called X-welding tongs for resistance spot welding especially of sheet metal, such as flat steel for automotive manufacturing. The welding tongs 1 comprise a drive unit 2, having a motor 4 and a gearing 6. The motor 4 and the gearing 6 are indicated only schematically by a broken line, as they are arranged inside a common housing 8. The common housing 8 is two pieces, comprising for example in embodiments (see FIG. 3) a motor housing portion and a gearing housing portion, with a flange arranged between the motor housing portion and the gearing housing portion.

The motor and the gearing need not necessarily be arranged exclusively in the respective housing portions, it may also occur in embodiments that parts of the motor or of the gearing also protrude into the other respective housing portion.

The welding tongs 1 comprise a first tong arm 11 and a second tong arm 12. The first tong arm 11 is connected to a driven element of the gearing 6, so that with the drive unit 2 the first tong arm 11 can be turned about an axis of rotation 14 of the welding tongs 1. The motor 4 and the gearing 6 are arranged coaxially to each other. Furthermore, the motor 4 and the gearing 6 are also arranged coaxially to the axis of rotation 14 of the welding tongs 1, so that an extremely compact design results.

The second tong arm 12 is fixed to the housing 8 of the drive unit 2, so that the second tong arm 12 remains stationary in regard to a system of coordinates of the drive unit 2. The second tong arm 12 is secured to the flange 9, and the abutment plane 29 is defined at the boundary surface between the flange 9 and the tong arm.

With the second tong arm, a bracket is formed as a single piece or seperately in typical embodiments, making possible a fastening of the welding tongs to a robot. In other typical embodiments, the second tong arm is fastened directly to a bracket. In other typical embodiments, the second tong arm is not fastened to the bracket, but instead an additional flange may be provided on the housing, for example, in order to fasten the welding tongs to a bracket.

In other typical embodiments, the first tong arm may also be fastened on or to a bracket, so that the overall drive unit with the second tong arm rotates about the first tong arm when the drive unit is activated. This is encompassed by the phrasing that the first tong arm rotates.

In preferred embodiments, the motor is connected directly to the gearing, especially preferably a driven shaft of the motor engages with the gearing or with a first gearing stage of the gearing. The gearing or a first gearing stage of the gearing are therefore preferably configured as a coaxial gearing.

The first tong arm is typically connected directly or indirectly in a torque-proof manner to a driven element of the gearing, such as a tooth carrier or a planet carrier. This means, in particular, that no further gearing, toothed wheels or toothed belts are interposed in between.

The first tong arm 11 of the welding tongs 1 has a first step 21 in the direction of the axis of rotation 14 in the direction of the motor 4. In this way, a work plane 25 of the welding tongs 1 is displaced relative to a first fastening plane 27 of the first tong arm 11 in the direction of the motor 4 along the axis of rotation 14.

The second tong arm 12 has no step, i.e., it is step-less. Since the second tong arm 12 is fastened to the centrally positioned flange 9, the second tong arm 12 needs no step. This increases the rigidity and reduces the required design space. The abutment plane 29 substantially coincides with the work plane 25. “Substantially” can mean, for example, that the distance between the work plane 25, in which the working point (not shown) lies, and the abutment plane 29 is less than the thickness of the second tong arm 12. In this application, further examples of an interpretation of “substantially coincides” are given in other places.

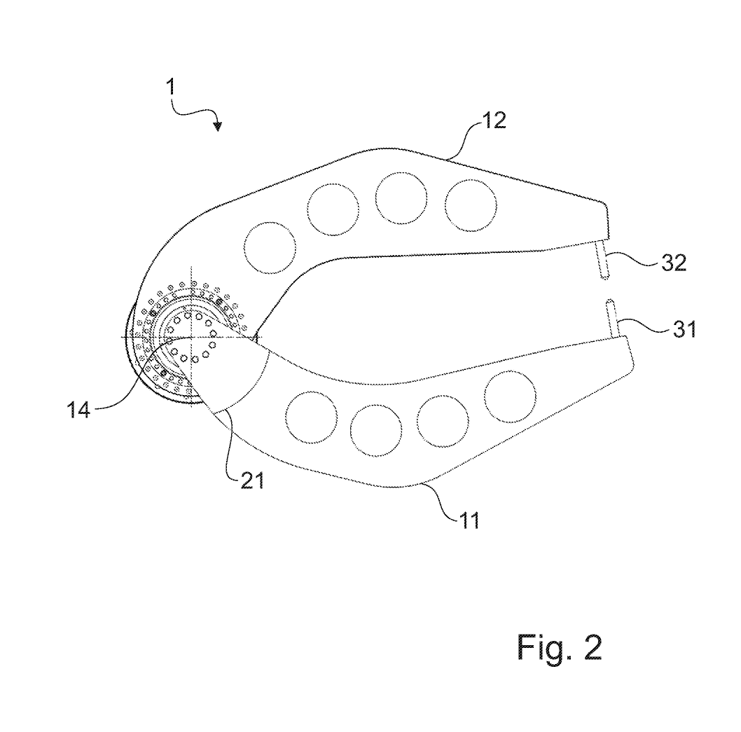

In FIG. 2, the welding tongs 1 of FIG. 1 is shown schematically in a side view. For the description of the individual parts, reference is made to the description for FIG. 1. In FIG. 2 there are additionally shown a first electrode 31 and a second electrode 32. The first electrode 31 is fastened on the first tong arm 11 and the second electrode 32 on the second tong arm 12. The tip of the second electrode 32 here forms the working point of the welding tongs 1, wherein the work plane 25 (FIG. 1) runs through the tips of the electrodes 31 and 32 and lies in the plane of movement of the electrode 31. The electrode 31 can perform a rotary movement about the axis of rotation 14, when it is driven by the drive unit 2 (FIG. 1).

FIG. 3 shows schematically a cross sectional view of the drive unit 2 with parts of the welding tongs 1. Once again, reference is made to the descriptions of FIGS. 1 and 2 for the description of many parts, axes, and planes which are also represented in FIG. 3.

The gearing is represented in more detail in FIG. 3 than in FIG. 1, but also heavily schematically. The gearing comprises a planetary gearing as the first gearing stage 6.1 and a galaxy gearing as the second gearing stage 6.2.

The sun wheel (not shown) of the planetary gearing is fastened on the motor driven shaft 36 of the motor 4. The motor driven shaft 36 thus also forms the input shaft of the first gearing stage 6.1 as a single piece.

The galaxy gearing has an inner situated cam disk (not shown), which is arranged on a shaft connected to the power takeoff of the planetary gearing.

The cam disk has two bulges, which ensure that radially movable teeth 38 come into engagement with an internal ring gear 40. The internal ring gear 40 is arranged between two driven bearings 42 and 44 of the gearing 6. An outer driven bearing 42 is arranged on the side of the internal ring gear 40 facing away from the motor, and an inner driven bearing 44 is arranged on the motor side of the internal ring gear 40.

The layout of the second gearing stage 6.2 can be found in greater detail for example in the aforementioned DE 10 2015 105 525 A1, wherein a tooth carrier 46 serves as the driven element, receiving the radially movable teeth 38. The first tong arm 11 is secured directly to the driven element, which comprises the tooth carrier 46. In this way, the first tong arm 11 is mounted by the driven bearings 42 and 44. The work plane 25 of the welding tongs 1 lies through the step 21 on the motor side of both the driven bearing plane of the outer driven bearing 42 and on the motor side of the driven bearing plane of the inner driven bearing 44.

The invention is not confined to the above described sample embodiments, for example, the second arm may be fixed to any desired side of the drive unit. Instead, the scope of the invention is defined by the claims.

### REFERENCE NUMBERS

Welding tongs
Drive unit
Motor
Gearing
6.1 First gearing stage (planetary gearing/planetary prestage)
6.2 Second gearing stage (galaxy gearing)
8 Housing
8.1 Motor housing portion
8.2 Gearing housing portion
9 Flange
11 First tong arm
12 Second tong arm
14 Axis of rotation
21 First step
25 Work plane
27 First fastening plane
29 Abutment plane
31 First electrode
32 Second electrode
36 Motor driven shaft
38 Teeth
40 Internal ring gear
42 Outer driven bearing
44 Inner driven bearing
46 Tooth carrier

What is claimed is:

1. Welding tongs, comprising
a first tong arm,
a second tong arm, and
a drive unit comprising a motor and a gearing for rotating the first tong arm relative to the second tong arm secured on a housing of the drive unit about an axis of rotation of the welding tongs,
wherein the motor and the gearing are arranged coaxially in the axis of rotation, and
wherein the second tong arm is fastened to the housing in an abutment plane, which is situated on the motor side of an outer driven bearing plane of the drive unit.

2. Welding tongs according to claim 1, wherein the housing comprises a flange arranged between a motor housing portion of the housing and a gearing housing portion of the housing, on which the second tong arm is secured.

3. Welding tongs according to claim 1, wherein the first tong arm is mounted by at least one driven bearing of the gearing situated in the driven bearing plane and able to turn about the axis of rotation.

4. Welding tongs according to claim 1, wherein the first tong arm has a step in the direction of the axis of rotation.

5. Welding tongs according to claim 4, wherein the step of the first tong arm forms an offset, so that at least one of a working point and a work plane of the welding tongs lies on the motor side of a fastening plane of the first tong arm.

6. Welding tongs according to claim 1, wherein the second tong arm is configured without a step.

7. Welding tongs according to claim 1, wherein the gearing comprises a first gearing stage and a second gearing stage.

8. Welding tongs according to claim 7, wherein the first gearing stage is configured as a planetary prestage.

9. Welding tongs according to claim 7, wherein the second gearing stage comprises a cam disk for the driving of radially movable teeth and an internal ring gear.

10. Welding tongs according to claim 9, wherein the internal ring gear is situated between the outer driven bearing plane of an outer driven bearing and an inner driven bearing plane of an inner driven bearing of the gearing.

11. Welding tongs according to claim 1, wherein at least one of the working point of the welding tongs and the abutment plane lies on the motor side of an inner driven bearing plane perpendicular to the axis of rotation and extending through an inner driven bearing of the gearing.

12. Welding tongs according to claim 5, wherein the distance from the work plane to the abutment plane is less than 40% of the length of the drive unit.

13. Use of the welding tongs according to claim 1 for the welding of sheet metal.

14. Welding tongs according to claim 1, wherein the welding tongs are X-welding tongs for resistance spot welding.
